(19) United States
(12) Patent Application Publication
(10) Pub. No.: US 2026/0263962 A1
(43) Pub. Date: Sep. 10, 2026

(54) PROCESS FOR FRACTIONATING A STREAM

(71) Applicant: UOP LLC, Rosemont, IL (US)

(72) Inventors: Kiran Ladkat, Gurgaon (IN); Donald Eizenga, Elk Grove Village, IL (US); Amit Munjal, Gurgaon (IN); Suvrendra Chakraborty, Gurgaon (IN)

(21) Appl. No.: 19/551,453

(22) Filed: Feb. 26, 2026

Related U.S. Application Data
(60) Provisional application No. 63/769,616, filed on Mar. 10, 2025.

(51) Int. Cl. B01D 3/34; B01D 3/32; C10G 7/00; C10G 67/02

(52) U.S. Cl. CPC B01D 3/346; B01D 3/322; C10G 7/00; C10G 67/02; C10G 2400/08

(57) ABSTRACT

A process of fractionating a stream is disclosed. The process comprises fractionating a reactor effluent stream in a fractionation column. A reboiling stream is taken from a reboil outlet in a side of the fractionation column. The reboiling stream is combined with a stripping vapor stream to provide a mixed reboiling stream. The mixed reboiling stream is heated in a reboiler to vaporize less than 70 vol % of the mixed reboiling stream to produce a reboiled stream. The reboiled stream is charged to the fractionation column through a reboiled inlet in a side of the fractionation column. A stripping vapor stream may be fed to the fractionation column near a bottom stage. An overhead product stream and a bottom product stream is taken from the fractionation column.

### FIELD

The field is related to a process of fractionating a stream. Particularly, the field may relate to a process of fractionating a hydroprocessed stream.

### BACKGROUND

As the demand for fuel increases worldwide, there is increasing interest in producing fuels and blending components from sources other than crude oil.

Hydroprocessing can include processes which convert hydrocarbons in the presence of hydroprocessing catalyst and hydrogen to more valuable products. Hydrotreating is a process in which hydrogen is contacted with hydrocarbons in the presence of hydrotreating catalysts which are primarily active for the removal of heteroatoms, such as sulfur, nitrogen, oxygen and metals from the hydrocarbon feedstock. In hydrotreating, hydrocarbons with double and triple bonds such as olefins may be saturated.

Hydroisomerization improves cold flow properties of fuel products, for example, diesel and jet fuel products. Hydroisomerization or hydrodewaxing is a hydroprocessing process that increases the alkyl branching on a hydrocarbon backbone in the presence of hydrogen and hydroisomerization catalyst to improve cold flow properties of the hydrocarbon. Hydroisomerization includes hydrodewaxing herein.

Hydrocracking is a hydroprocessing process in which hydrocarbons crack in the presence of hydrogen and hydrocracking catalyst to lower the molecular weight of hydrocarbons. Depending on the desired output, a hydrocracking unit may contain one or more beds of the same or different catalyst.

Synthetic transportation fuels are increasingly in demand because they contain no sulfur or aromatics and typically have high diesel cetane numbers and can be adjusted to the required cloud point or cold filter plugging point (CFPP) specification. Similarly, synthetic jet fuels have high smoke point and can be tailed to the required freeze point specification. The Fischer-Tropsch process used to make synthetic transportation fuels, however, results in a syncrude product containing oxygenates (“FT oxygenates”) and heavy boiling point components which are waxy paraffinic materials with poor cold flow properties. The FT oxygenates typically include primary and internal alcohols, which constitute the major portion of the total FT oxygenate, as well as aldehydes, ketones and acids. The heavy boiling point components typically include paraffin waxes (n-paraffin and mono-methyl branched isoparaffins). The presence of FT oxygenates and olefins in synthetic fuel products is not desired because of thermal stability issues and regulatory constraints.

The FT oxygenates, olefins, and heavy boiling point components may be removed through a processes such as hydroprocessing. The term “hydroprocessing” as used herein means hydrotreating, hydrocracking, hydroisomerization, hydrodewaxing, or a combination of two or more of these processes. The FT oxygenate and olefin content is generally higher in the lower boiling range distillation cuts of the Fischer-Tropsch product and declines precipitously above a 600° F. cut point.

Fischer-Tropsch liquids upgrading/refining units are often large and involve large capital costs including a higher fuel consumption. Processes for economic conversion of Fischer-Tropsch liquids and waxes into lubricant base stock and/or transportation fuels are desired.

### SUMMARY

The present disclosure provides a process for fractionating a stream. The process comprises fractionating a reactor effluent stream in a fractionation column. A reboiling stream is taken from a reboil outlet in a side of the fractionation column. The reboiling stream is combined with a stripping vapor stream to provide a mixed reboiling stream. The mixed reboiling stream is heated in a reboiler to vaporize less than 70 vol % of the mixed reboiling stream to produce a reboiled stream. The reboiled stream is charged to the fractionation column through a reboiled inlet in a side of the fractionation column. A stripping vapor stream may be provided at the bottom of fractionation column. An overhead product stream and a bottom product stream is taken from the fractionation column. The present process provides for reduced energy consumption in the fractionation column for fractionating a hot separator liquid stream and a cold separator liquid stream.

### BRIEF DESCRIPTION OF THE DRAWINGS

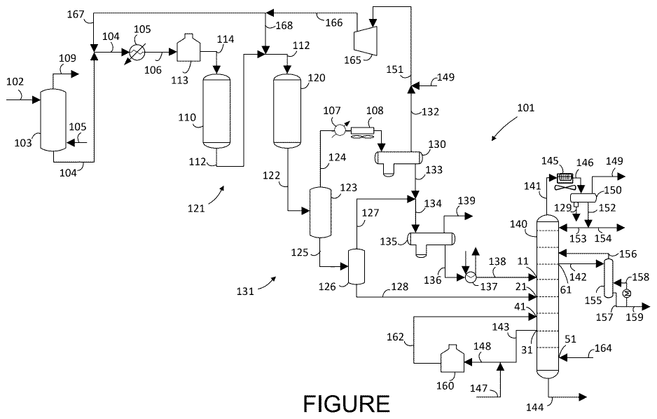

The FIG. 1s a schematic process flow diagram of a process of fractionating a stream in accordance with the present disclosure.

### Definitions

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” or “directly” means that flow from the upstream component enters the downstream component without passing through a fractionation or conversion unit to undergo a compositional change due to physical fractionation or chemical conversion.

The term “indirect communication” means that flow from the upstream component enters the downstream component after passing through a fractionation or conversion unit to undergo a compositional change due to physical fractionation or chemical conversion.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripper columns may omit a reboiler at a bottom of the column and instead provide heating requirements and separation impetus from a fluidized inert media such as steam. Stripping columns typically feed a top tray and take a main product from the bottom.

As used herein, the term “a component-rich stream” means that the rich stream coming out of a vessel has a greater concentration of the component than the feed to the vessel.

As used herein, the term “a component-lean stream” means that the lean stream coming out of a vessel has a smaller concentration of the component than the feed to the vessel.

As used herein, the term “boiling point temperature” means atmospheric equivalent boiling point (AEBP) as calculated from the observed boiling temperature and the distillation pressure, as calculated using the equations furnished in ASTM D86 or ASTM D2887.

As used herein, the term “True Boiling Point” (TBP) means a test method for determining the boiling point of a material which corresponds to ASTM D-2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “T80” or “T90” means the temperature at which 80 mass percent or 90 mass percent, as the case may be, respectively, of the sample boils using ASTM D-86 or TBP.

As used herein, the term “initial boiling point” (IBP) means the temperature at which the sample begins to boil using ASTM D2887, ASTM D-86 or TBP, as the case may be.

As used herein, the term “final boiling point” (FBP) means the temperature at which the sample has all boiled off using ASTM D2887, ASTM D-86 or TBP, as the case may be.

As used herein, the term “jet fuel range material” means hydrocarbons boiling in the range of an IBP between about 85° C. (185° F.) and about 135° C. (275° F.) or a T5 between about 110° C. (230° F.) and about 160° C. (320° F.) and the “recycle cut point” comprising a T95 between about 295° C. (563° F.) and about 315° C. (599° F.) using the TBP distillation method. Hydrocarbons beyond the “recycle cut point” and up to the “diesel cut point” comprising a T95 between about 343° C. (650° F.) and about 399° C. (750° F.) are the “diesel boiling range” material using the TBP distillation method.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure.

As used herein, the term “predominant” or “predominate” means greater than 50%, suitably greater than 75% and preferably greater than 90%.

As used herein, the term “Cₓ” are to be understood to refer to molecules having the number of carbon atoms represented by the subscript “x”. Similarly, the term “Cₓ−” refers to molecules that contain less than or equal to x and preferably x and less carbon atoms. The term “Cₓ+” refers to molecules with more than or equal to x and preferably x and more carbon atoms.

As used herein, the term “carbon number” refers to the number of carbon atoms per hydrocarbon molecule and typically a paraffin molecule.

The term “hydrocracking” as used herein refers to a process having all or some of the reactions associated with hydrotreating, as well as cracking reactions, which result in molecular weight and boiling point reduction and molecular rearrangement, or isomerization.

The terms “paraffin” and “alkane” are used interchangeably and refer to a hydrocarbon identified by saturated carbon chains, which can be normal (straight), or branched, and described by a general formula CₙDH₂ₙ₊₂, where n is an integer. Paraffins or alkanes are substantially free of carbon-carbon double bonds (C═C).

The term “olefin,” also known as “alkene” is defined as a hydrocarbon containing at least one carbon-carbon double bond, and described by a general formula CₙH₂ₙ, where n is an integer.

The term “wax” when used in this disclosure refers to a hydrocarbon wax and may typically obtained as the highest boiling fraction or one of the highest boiling fractions from a Fischer-Tropsch derived product. The synthetic hydrocarbon wax is most often a solid at room temperature. For the purpose of this disclosure, a synthetic hydrocarbon wax includes a C20+ wax, suitably a C20-C150 hydrocarbonaceous compounds with a boiling point typically greater than 340° C. (645° F.), more preferably, a Fischer-Tropsch (FT) C20-C45 wax.

The term “naphtha” when used in this disclosure refers to a liquid product having between C4 and C12 carbon atoms in the backbone and will have a boiling range generally below that of diesel, but wherein the upper end of the boiling range could overlap that of the initial boiling point of diesel. The “naphtha” can have a T90 boiling range between about 70° C. (160° F.) and about 180° C. (356° F.).

The term “kerosene” refers to a C₆ to C₁₆ hydrocarbon which boils in the range from 85° C. (185° F.) to 332° C. (630° F.).

The term “lubricant base stock” or “lube base stock” is defined in accordance with the American Petroleum Institute, which has defined a base stock “as a lubricant component that is produced by a single manufacturer to the same specifications (independent of feed source or manufacturer's location); that meets the same manufacturer's specification; and that is identified by a unique formula, product identification number or both”. A base oil is defined as “the base stock or blend of base stocks used in an API licensed oil”. Although they are referenced for other applications, API base stock applications apply mainly to components used in engine oils. Base stocks are classified into two broad types, naphthenic and paraffinic, depending on the crude types from which they are derived. Paraffinic crudes contain wax, comprising largely n- and iso-paraffins which have high melting points. One non-limiting example lubricant base stock includes a C20-C45 n-paraffin and iso-paraffin wax having a kinematic viscosity at 100° C. (212° F.) in the range of 1 to 20 centistokes (cSt).

### DETAILED DESCRIPTION

In the FIGURE, in accordance with an exemplary embodiment, a process 101 is shown for fractionating a stream. The process 101 comprises a reactor section 121 and a separation section 131. A feed line 102 transports a hydrocarbon feed stream to the reactor section 121. In an aspect, the hydrocarbon feed stream in line 102 may comprise liquid products from a Fischer-Tropsch reactor unit. The liquid products from the Fischer-Tropsch reactor unit may include hydrocarbons ranging from methane (CH₄) to high molecular weight paraffinic waxes containing more than 100 carbon atoms.

The synthetic production of hydrocarbons by the catalytic reaction of carbon monoxide and hydrogen is generally referred to as a Fischer-Tropsch reaction. Fischer-Tropsch synthesis is known to yield a broad mixture of products including primarily paraffins, and some olefins. Some Fischer-Tropsch processes yield mixtures enriched with C₅-C₃₀ alkanes and also containing a significant quantity of olefins and oxygenated compounds such as alcohols or acids. The Fischer-Tropsch hydrocarbon synthesis reaction is preferably carried out at a temperature in the range of from about 175° C. (350° F.) to about 290° C. (550° F.). The effluent from the Fischer-Tropsch reactor is cooled, condensed and continuously fed to product separators where the outlet is separated into water, a low heating value tail gas, and the desired hydrocarbon liquid product. The Fischer-Tropsch reactor liquid product (FTRL) may be distilled in a fractionator into two or more streams. A Light Fischer-Tropsch Liquid (LFTL) and a Heavy Fischer-Tropsch Liquid (HFTL) which are recovered from fractionator. Light Fischer-Tropsch liquids are frequently used as a raw material for obtaining various petrochemical products, such as, e.g., petroleum distillates, or diesel fuels, among others.

In an exemplary embodiment, the hydrocarbon feed stream in line 102 may comprise a light Fischer-Tropsch liquid (LFTL) and a heavy Fischer-Tropsch liquid (HFTL). The LFTL may comprise from about C2 to about C24 hydrocarbons, preferably about C5 to about C16 hydrocarbons. The HFTL may comprise from about C10 to C50+ hydrocarbons, preferably about C7 to about C26 hydrocarbons.

The hydrocarbon feed stream in line 102 may be passed to a stripping column 103 to strip light gases from it. A suitable stripping media in line 105 is also passed to the stripping column 103. In alternate embodiment, the stripping column 103 may comprise a reboiler. A stripping media which is an inert gas or vapor such as steam from a stripping media line 105 may be used to strip light gases from the hydrocarbon feed stream in line 102. An overhead stream in line 109 comprising the light gases is taken from the overhead of the stripping column 105. A stripped hydrocarbon feed stream in line 104 is charged to the reactor section 121.

In an embodiment, the stripping column 103 may be operated with a bottoms temperature between about 149° C. (300° F.) and about 260° C. (500° F.) and an overhead pressure of about 0.01 MPa (gauge) (1 psig) to about 0.7 MPa (gauge) (100 psig).

The stripped hydrocarbon feed stream in line 104 may be combined with a first hydrogen stream in line 167 to provide a combined feed stream in line 104. The combined feed stream in line 104 may be heated in a combined feed exchanger 105 to produce a heated feed stream in line 106. The heated feed stream in line 106 may be further heated in a charge heater 113 to produce a charge stream in line 114. The charge stream in line 108 is charged to the reactor section 121.

In an embodiment, the reactor section 121 may be a hydroprocessing reactor section comprising a first hydroprocessing reactor 110 and a second hydroprocessing reactor 120. The charge stream in line 114 may be charged to the first hydroprocessing reactor 110 and hydroprocessed in the presence of a catalyst to produce a hydroprocessed stream.

In an exemplary embodiment, the first hydroprocessing reactor 110 may be a hydrocracking reactor for hydrocracking the charge stream in the presence of a hydrocracking catalyst. The hydrocracking reactor 110 may comprise single or multiple catalyst beds and various combinations of hydrocracking catalyst in one or more vessels. The hydrocracking reactor 110 may be operated in a co-current mode of operation. Fixed bed, trickle bed down-flow or fixed bed liquid filled up-flow modes are both suitable. The charge stream in line 113 may be hydrocracked over a hydrocracking catalyst in the hydrocracking reactor 110 in the presence of the first hydrogen stream to provide a hydrocracked stream.

The hydrocracking reactor 110 may operate at a partial conversion of more than about 30 vol % or full conversion of at least about 90 vol % of the feed based on total conversion. The hydrocracking catalyst in the hydrocracking reactor 110 may utilize amorphous silica-alumina bases or zeolite bases combined with one or more Group VIII or Group VIB metal hydrogenating components to selectively produce a balance of light diesel and jet fuel distillate. In another aspect, a catalyst which comprises, in general, any crystalline zeolite cracking base upon which is deposited a Group VIII metal hydrogenating component may be suitable. Additional hydrogenating components may be selected from Group VIB for incorporation with the zeolite base.

The zeolite cracking bases are sometimes referred to in the art as molecular sieves and are usually composed of silica, alumina and one or more exchangeable cations such as sodium, magnesium, calcium, rare earth metals, etc. They are further characterized by crystal pores of relatively uniform diameter between about 4 and about 14 Angstroms. It is preferred to employ zeolites having a relatively high silica/alumina mole ratio between about 3 and about 12. Suitable zeolites found in nature include, for example, mordenite, stilbite, heulandite, ferrierite, dachiardite, chabazite, erionite and faujasite. Suitable synthetic zeolites include, for example, the B, X, Y and L crystal types, e.g., synthetic faujasite and mordenite. The preferred zeolites are those having crystal pore diameters between about 8 and 12 Angstroms, wherein the silica/alumina mole ratio is about 4 to 6. One example of a zeolite falling in the preferred group is synthetic Y molecular sieve.

The natural occurring zeolites are normally found in a sodium form, an alkaline earth metal form, or mixed forms. The synthetic zeolites are nearly always prepared in the sodium form. In any case, for use as a cracking base it is preferred that most or all of the original zeolitic monovalent metals be ion-exchanged with a polyvalent metal and/or with an ammonium salt followed by heating to decompose the ammonium ions associated with the zeolite, leaving in their place hydrogen ions and/or exchange sites which have actually been decationized by further removal of water. Hydrogen or “decationized” Y zeolites of this nature are more particularly described in U.S. Pat. No. 3,100,006.

Mixed polyvalent metal-hydrogen zeolites may be prepared by ion-exchanging with an ammonium salt, then partially back exchanging with a polyvalent metal salt and then calcining. In some cases, as in the case of synthetic mordenite, the hydrogen forms can be prepared by direct acid treatment of the alkali metal zeolites. In one aspect, the preferred cracking bases are those which are at least about 10 wt %, and preferably at least about 20 wt %, metal-cation-deficient, based on the initial ion-exchange capacity. In another aspect, a desirable and stable class of zeolites is one wherein at least about 20 wt % of the ion exchange capacity is satisfied by hydrogen ions.

The active metals employed in the preferred hydrocracking catalysts of the present disclosure as hydrogenation components are those of Group VIII, i.e., iron, cobalt, nickel, ruthenium, rhodium, palladium, osmium, iridium and platinum. In addition to these metals, other promoters may also be employed in conjunction therewith, including the metals of Group VIB, e.g., molybdenum and tungsten. The amount of hydrogenating metal in the catalyst can vary within wide ranges. Broadly speaking, any amount between about 0.05 wt % and about 30 wt % may be used. In the case of the noble metals, it is normally preferred to use about 0.05 to about 2 wt % noble metal. Noble metals may be preferred as the hydrogenation metal on the hydrocracking catalyst to provide selectivity to jet fuel due to the absence of hydrogen sulfide and ammonia which can deactivate noble metal catalysts, which are not present in FT liquids.

The method for incorporating the hydrogenation metal is to contact the base material with an aqueous solution of a suitable compound of the desired metal wherein the metal is present in a cationic form. Following addition of the selected hydrogenation metal or metals, the resulting catalyst powder is then filtered, dried, pelleted with added lubricants, binders or the like if desired, and calcined in air at temperatures of, e.g., about 371° C. (700° F.) to about 648° C. (1200° F.) in order to activate the catalyst and decompose ammonium ions. Alternatively, the base component may be pelleted, followed by the addition of the hydrogenation component and activation by calcining.

The foregoing catalysts may be employed in undiluted form, or the powdered catalyst may be mixed and copelleted with other relatively less active catalysts, diluents or binders such as alumina, silica gel, silica-alumina cogels, activated clays and the like in proportions ranging between about 5 and about 90 wt %. These diluents may be employed as such, or they may contain a minor proportion of an added hydrogenating metal such as a Group VIB and/or Group VIII metal. Additional metal promoted hydrocracking catalysts may also be utilized in the process of the present disclosure which comprises, for example, aluminophosphate molecular sieves, crystalline chromosilicates and other crystalline silicates. Crystalline chromosilicates are more fully described in U.S. Pat. No. 4,363,178.

By one approach, the hydrocracking conditions in the hydrocracking reactor 110 may include a temperature from about 290° C. (550° F.) to about 468° C. (875° F.), preferably 300° C. (572° F.) to about 445° C. (833° F.), a pressure from about 2.7 MPa (gauge) (400 psig) to about 20.7 MPa (gauge) (3000 psig), a LHSV from about 0.4 to less than about 20 hr⁻¹ and a hydrogen rate of about 253 Nm³/m³ (1,500 scf/bbl) to about 2,527 Nm³/m³ oil (15,000 scf/bbl).

A hydroprocessed, preferably hydrocracked effluent stream is discharged in line 112 from the hydrocracking reactor 110. The hydrocracked effluent stream in line 112 may be further hydroprocessed in the second hydroprocessing reactor 120. The hydrocracked effluent stream in line 112 may be combined with a second hydrogen stream in line 168 to provide a combined effluent stream in line 112. The combined effluent stream in line 112 is charged to the second hydroprocessing reactor 120. In an exemplary embodiment, the second hydroprocessing reactor 120 may be a hydroisomerization reactor for hydroisomerizing the hydrocracked effluent stream in the presence of a hydroisomerization catalyst.

Hydroisomerization, including hydrodewaxing, of the normal hydrocarbons in the hydroisomerization reactor 120 can be accomplished over one or more beds of hydroisomerization catalyst, and the hydroisomerization may be operated in a co-current mode of operation. Fixed bed, trickle bed down-flow or fixed bed liquid filled up-flow modes are both suitable.

Suitable hydroisomerization catalysts may comprise a metal of Group VIII (IUPAC 8-10) of the Periodic Table and a support material. Suitable Group VIII metals include platinum and palladium, each of which may be used alone or in combination. The hydroisomerization catalyst may include non-noble metals which are not as susceptible to sulfur deactivation in a sour environment. Examples of suitable non-noble metals include Ni, Mo, Co, W, Mn, Cu, Zn or Ru. Mixtures of hydrogenation metals may also be used such as Co/Mo, Ni/Mo and Ni/W. The amount of hydrogenation metal or metals may range from 0.1 to 5 wt. %, based on the catalyst weight. Methods of loading metal onto the support material include, for example, impregnation of the support material with a metal salt of the hydrogenation component and heating. The catalyst support material containing the hydrogenation metal may also be sulfided prior to use.

The support material may be amorphous or crystalline. Suitable support materials include amorphous alumina, amorphous silica-alumina, ferrierite, ALPO-31, SAPO-11, SAPO-31, SAPO-37, SAPO-41, SM-3, MgAPSO-31, FU-9, NU-10, NU-23, ZSM-12, ZSM-22, ZSM-23, ZSM-35, ZSM-48, ZSM-50, ZSM-57, MeAPO-11, MeAPO-31, MeAPO-41, MgAPSO-11, MgAPSO-31, MgAPSO-41, MgAPSO-46, ELAPO-11, ELAPO-31, ELAPO-41, ELAPSO-11, ELAPSO-31, ELAPSO-41, laumontite, cancrinite, offretite, hydrogen form of stillbite, magnesium or calcium form of mordenite, and magnesium or calcium form of partheite, each of which may be used alone or in combination. ALPO-31 is described in U.S. Pat. No. 4,310,440. SAPO-11, SAPO-31, SAPO-37, and SAPO-41 are described in U.S. Pat. No. 4,440,871. SM-3 is described in U.S. Pat. Nos. 4,943,424; 5,087,347; 5,158,665; and 5,208,005. MgAPSO is a MeAPSO, which is an acronym for a metal aluminumsilicophosphate molecular sieve, where the metal, Me, is magnesium (Mg). Suitable MgAPSO-31 catalysts include MgAPSO-31. MeAPSOs are described in U.S. Pat. No. 4,793,984, and MgAPSOs are described in U.S. Pat. No. 4,758,419. MgAPSO-31 is a preferred MgAPSO, where 31 means a MgAPSO having structure type 31. Many natural zeolites, such as ferrierite, that have an initially reduced pore size can be converted to forms suitable for olefin skeletal isomerization by removing associated alkali metal or alkaline earth metal by ammonium ion exchange and calcination to produce the substantially hydrogen form, as taught in U.S. Pat. Nos. 4,795,623 and 4,924,027. Further catalysts and conditions for skeletal isomerization are disclosed in U.S. Pat. Nos. 5,510,306, 5,082,956, and 5,741,759. The hydroisomerization catalyst may also comprise a modifier selected from the group consisting of lanthanum, cerium, praseodymium, neodymium, samarium, gadolinium, terbium, and mixtures thereof, as described in U.S. Pat. Nos. 5,716,897 and 5,851,949. Other suitable support materials include ZSM-22, ZSM-23, and ZSM-35, which are described for use in dewaxing in U.S. Pat. No. 5,246,566 and in the article entitled S. Miller, “New Molecular Sieve Process for Lube Dewaxing by Wax Isomerization,” 2 Microporous Materials 439-449 (1994). U.S. Pat. Nos. 5,444,032 and 5,608,968 teach a suitable bifunctional catalyst which is constituted by an amorphous silica-alumina gel and one or more metals belonging to Group VIIIA and is effective in the hydroisomerization of long-chain normal paraffins containing more than 15 carbon atoms. U.S. Pat. Nos. 5,981,419 and 5,908,134 teach a suitable bifunctional catalyst which comprises: (a) a porous crystalline material isostructural with beta-zeolite selected from boro-silicate (BOR-B) and boro-alumino-silicate (Al-BOR-B) in which the molar SiO₂:Al₂O₃ ratio is higher than 300:1; (b) one or more metal(s) belonging to Group VIIIA, selected from platinum and palladium, in an amount comprised within the range of from 0.05 to 5% by weight. V. Calemma et al., App. Catal. A: Gen., 190 (2000), 207 teaches yet another suitable catalyst. Alumina or silica may be added to the support material.

Hydroisomerization conditions in the hydroisomerization reactor 120 generally include a temperature of about 150° C. (302° F.) to about 450° C. (842° F.) and a pressure of about 1.7 MPa (gauge) (250 psig) to about 13.8 MPa (gauge) (2000 psig). In another embodiment, the hydroisomerization conditions in the hydroisomerization reactor 120 include a temperature of about 300° C. (572° F.) to about 360° C. (680° F.) and a pressure of about 3.1 MPa (gauge) (450 psig) to about 6.9 MPa (gauge) (1000 psig).

A hydroisomerized effluent stream in a hydroisomerized line 122 from the hydroisomerization reactor 120 is a branched-paraffin-rich stream. By the term “rich” it is meant that the effluent stream has a greater concentration of branched paraffins than the stream entering the hydroisomerization reactor 120 and preferably comprises greater than 50 mass-% branched paraffins of the total paraffin content. It is envisioned that the hydroisomerized effluent stream in line 122 may contain at least 80, 90 or 95 mass % branched paraffins of the total paraffin content. Hydroisomerization conditions in the hydroisomerization reactor 120 are selected to avoid undesirable cracking, so the predominant product in the hydroisomerized stream in the hydroisomerized line 122 is a branched paraffin. By avoiding undesirable hydrocracking, the hydroisomerized stream in the hydroisomerized line 122 will have the same composition with regard to carbon number as the incoming feed to the hydroisomerization reactor 120. For example, although the incoming feed to the hydroisomerization reactor 120 may have 8 wt % paraffins with four carbon atoms, the hydroisomerized stream will also have 8 wt % paraffins with four carbon atoms although the hydroisomerized stream will have a greater proportion of paraffins that are isobutanes than the hydroisomerization feed stream and the hydroisomerization feed stream will have a greater proportion of paraffins that are normal butanes than the hydroisomerized stream. This principle will apply typically to paraffins of all carbon numbers passing through the hydroisomerization reactor 120, but particularly applicable to paraffins with carbon numbers of four to seventeen. The optimal amount of remaining normal paraffins in line 122 is dependent on the selectivity of the hydroisomerization catalysts but might typically be between about 1 to about 7 wt-%.

The hydroisomerized effluent stream in line 122 is passed to the separation section 131. In an embodiment, the separation section 131 may comprise a hot separator 123, a cold separator 130, and a fractionation column 140. As shown in FIGURE, the hydroisomerized effluent stream in line 122 is passed to the hot separator 123. The hot separator 123 may be operated at a temperature of about 200° C. (392° F.) to about 315° C. (600° F.). The hot separator 123 may be operated at a pressure of about the hydroisomerization reactor 120 but a little less accounting for pressure drop through the lines.

A hot hydroprocessed effluent stream is discharged in line 125 from the bottom of the hot separator 123. The hot hydroprocessed effluent stream in line 125 may be at a temperature between about 200° C. (392° F.) and about 315° C. (600° F.) and a pressure of about that the hot separator 123. A hot overhead stream is discharged in an overhead line 124 of the hot separator 123. The hot overhead stream in line 124 may be cooled in a heat exchanger 107 followed by an air cooler 108 and fed to the cold separator 130.

The separator section 131 may optionally include a hot flash drum 126. The hot hydroprocessed effluent stream in line 125 may be passed to the hot flash drum 126. The hot flash drum 126 flashes the hot hydroprocessed effluent stream at a lower pressure to separate a liquid flash hot hydroprocessing stream in flash hot hydroprocessing line 128 from a vaporous hot flash stream in hot flash overhead line 127. The liquid flash hot hydroprocessing stream in line 128 may be at a temperature between about 200° C. (392° F.) and about 315° C. (600° F.) and a pressure of between about 0.35 MPa (gauge) (50 psig) and about 6.2 MPa (gauge) (900 psig) which represent the conditions in the hot flash drum 126.

In the cold separator 130, the hot overhead stream in line 124 is separated to provide a cold overhead stream in line 132 and a cold hydroprocessing effluent stream in line 133. The cold hydroprocessing effluent stream in line 133 can be at a temperature of no more than about 100° C. and a pressure of about that the cold separator 130. Generally, the cold separator 130 can be operated at no more than about 100° C. (212° F.), preferably no more than about 70° C. (160° F.). The cold separator 130 may be operated at a pressure of about the hydroisomerization reactor 120 but a little less accounting for pressure drop through the lines and heat exchangers.

The cold overhead stream in line 132 may comprise hydrogen gas which can be recycled to the hydroprocessing reactor section 121. In an embodiment, the cold overhead stream in line 132 may be combined with a make-up hydrogen stream in line 149 to provide a combined hydrogen stream in line 151. The combined hydrogen stream in line 151 may be compressed in a recycle gas compressor 165 to provide a recycle hydrogen stream in line 166. The first hydrogen stream in line 167 and the second hydrogen stream in line 168 may be taken from the recycle hydrogen stream in line 166 which are charged to the hydroprocessing reactor section 121 as earlier described.

The separator section 131 may optionally include a cold flash drum 135. The cold hydroprocessing effluent stream in line 133 and the vaporous hot flash stream in line 127 may be charged to the cold flash drum 135. The cold flash drum 135 flashes the cold hydroprocessed effluent stream in line 133 and the vaporous hot flash stream in line 127 to separate a liquid flash cold hydroprocessing stream in a flash cold hydroprocessing line 136 from a vaporous cold flash stream comprising normally gaseous hydrocarbons in a cold flash overhead line 139. The liquid flash cold hydroprocessing stream in line 136 is at a temperature of no more than about 100° C. and a pressure of between about 0.35 MPa (gauge) (50 psig) and about 6.2 Mpa (gauge) (900 psig) which represent the conditions in the cold flash drum 135.

In accordance with the present disclosure, the liquid flash cold hydroprocessing stream in line 136 and the liquid flash hot hydroprocessing stream in line 128 are fractionated in the fractionation column 140. The liquid flash cold hydroprocessing stream in line 136 may be heated in a heat exchanger 137 to produce a heated liquid flash cold hydroprocessing stream in line 138. The heated liquid flash cold hydroprocessing stream in line 138 may be fed through a cold inlet 11 of the fractionation column 140. The liquid flash hot hydroprocessing stream in line 128 may be fed through a hot inlet 21 of the fractionation column 140. In an embodiment, the cold inlet 11 is above the hot inlet 21 of the fractionation column 140. In an embodiment, the cold inlet 11 is located at least one stage, preferably at least two stages above, more preferably at least three stages above the hot inlet 21 of the fractionation column 140.

The heated liquid flash cold hydroprocessing stream in line 138 and the liquid flash hot hydroprocessing stream in line 128 may not require further separation such as stripping before feeding into the fractionation column 140. In an aspect, the heated liquid flash cold hydroprocessing stream in line 138 and the liquid flash hot hydroprocessing stream in line 128 may be fed directly into the fractionation column 140. In a further embodiment, the hot hydroprocessed effluent stream in line 125 and the cold hydroprocessing effluent stream in line 133 may be passed directly to the fractionation column 140 without undergoing flash separations.

In the fractionation column 140 the heated liquid flash hot hydroprocessing stream in line 138 and the liquid flash hot hydroprocessing stream in line 128 are fractionated to produce an overhead product stream and a bottom product stream. The fractionation column 140 provides an overhead gaseous stream of naphtha in an overhead line 141. The fractionation overhead stream may be passed through a cooler condenser 145 and partially condensed to produce a cooled overhead stream in line 146. The cooled overhead stream in line 146 is passed to an overhead receiver 150 and separated from water and vapor to provide a fractionator overhead liquid stream in line 152. A water stream in line 129 may be collected from a boot of the overhead receiver 150. An overhead vapor stream in line 149 may be vented from the receiver. The fractionator overhead liquid in line 152 comprises unstabilized naphtha. A reflux stream may be taken in line 153 from the fractionator overhead liquid in line 152. An overhead product stream may be taken in line 154 from the fractionator overhead liquid in line 152.

The fractionation column 140 may be operated with a bottoms temperature between about 149° C. (300° F.) and about 425° C. (800° F.), preferably no more than about 385° C. (725° F.), and an overhead pressure of about 0.15 MPa (gauge) (20 psig), preferably no less than about 0.01 MPa (gauge) (1.5 psig), to no more than about 0.7 MPa (gauge) (100 psig). The temperature in the overhead receiver 150 may range from about 38° C. (100° F.) to about 66° C. (150° F.) and the pressure is essentially the same as in the overhead of the fractionation column 140.

Further, a reboiling stream may be taken in a reboiling line 143 from a reboiled outlet 31 from a side of the fractionation column 140. The reboiling stream in line 143 may be heated in a reboiler 160 to produce a reboiled stream in line 162. The reboiled stream in line 162 may be fed to the fractionation column 140 through a reboiled inlet 41 in a side of the fractionation column 140.

The fractionator column feed heater consumes a significant amount of fuel to provide the duty to boil and separate the one or more fuel products. The present process provides reduced fuel consumption for the fractionation column 140. The disclosed process reduces energy consumption for the fractionation column 140. The present process includes a fractionation column 140 with an upper reboiler. Further, a stripping vapor stream 164 may be fed from near the bottom section of the fractionation column 140 to assist in the separation.

In a typical process, the fractionation column feed heater usually requires more duty as compared with a reboiler heater to achieve the same separation between one or more fuel streams and the unconverted material. Conventionally, recirculation of the product fractionator bottom stream to an inlet of the fractionation column feed heater would be necessary to avoid excessive vaporizing at the outlet of the fractionation column feed heater. In order to avoid a higher reboiler outlet temperature which can result in thermal cracking and loss of fuel products, a bottoms reboiler fired heater is omitted in the fractionation column 140.

The present process includes a fractionation column 140 with an upper reboiler heater 160 and steam stripping in the bottom of the fractionation column. Further, the reboiler heater 160 may include injection of a stripping vapor stream in line 147 upstream of the reboiler. Also, a separate stripping vapor stream may be fed near the bottom of the fractionation column 140. The present process ensures the heater outlet temperature will not increase above about 380° C. (715° F.) to about 391° C. (735° F.). The expected reduction in fuel consumption is around 50% as compared to the conventional process with recycle and mixing of product fractionator feed heater streams.

The present improved process has the advantage of bulk separation and does not mix upstream cold and hot separator liquid streams. As shown in FIGURE, the heated liquid flash cold hydroprocessing stream in line 138 and the liquid flash hot hydroprocessing stream in line 128 are fed to different feed tray locations or stages of the fractionation column 140. The present process does not need any pre-flash drum and associated equipment upstream of fractionator column 140.

In an embodiment of the present disclosure, the reboiling stream in line 143 may be combined with a stripping vapor stream in line 147 to provide a mixed reboiling stream in line 148. In an exemplary embodiment, the stripping vapor stream in line 147 comprises steam. The mixed reboiling stream in line 148 may be fed to the reboiler 160. In an aspect, the reboiler 160 may be selected from a direct fired heater, an indirect hot oil heater, and an electric heater. In the reboiler 160, the mixed reboiling stream in line 148 is heated to vaporize a predetermined portion of the mixed reboiling stream to produce a reboiled stream having a temperature of less than about 380° C. (715° F.) to about 391° C. (735° F.). The predetermined portion may range from about 30 vol % to about 70 vol % of the mixed reboiling stream in line 148. In an exemplary embodiment, the mixed reboiling stream may be heated in the reboiler 160 to vaporize less than 80 vol %, preferably less than 70 vol %, of the mixed reboiling stream to produce a reboiled stream in line 162. In another exemplary embodiment, the mixed reboiling stream may be heated in the reboiler 160 to vaporize less than 50 vol % of the mixed reboiling stream to produce a reboiled stream in line 162.

In an aspect, the mixed reboiling stream in line 148 may be characterized by a T80 temperature of greater than about 343° C. (650° F.), preferably greater than about 357° C. (675° F.).

In an embodiment, the reboiling stream in line 143 may be taken from the reboiled outlet 31 from above the bottom theoretical stage of the fractionation column 140.

The mixed reboiling stream in line 162 is charged to the reboiled inlet 41 of the fractionation column 140. The mixed reboiling stream in line 162 is charged to the reboiled inlet 41 at a temperature of less than about 380° C. (715° F.) to about 391° C. (735° F.). The reboiled inlet 41 is located above the reboiled outlet 31 of the fractionation column 140. The reboiling stream in line 143 is taken from the reboiled outlet 31 at a location below the reboiled inlet 41 of the fractionation column 140. Further, the reboiling stream liquid can be drawn from an accumulator tray at the same accumulator tray location as the reboiler return.

A bottom stripping vapor stream in line 164 may be fed to the fractionation column 140 near its bottom. The bottom stripping vapor stream in line 164 may be fed near a bottom stage of the fractionation column 140 from a bottom inlet 51. In an embodiment, the bottom stripping vapor stream in line 164 comprises steam. In a further embodiment, the bottom stripping vapor stream in line 164 is fed at the bottom inlet 51 that is below the reboiled inlet 41.

The fractionation of the heated liquid flash hot hydroprocessing stream in line 138 and the liquid flash hot hydroprocessing stream in line 128 in the fractionation column 140 further produces a side product stream in line 142. In an aspect, the side product stream in line 142 comprises kerosene. The kerosene stream may be taken from the side outlet 61 of the fractionation column 140 in a side line 142. In an embodiment, the outlet 61 for the kerosene stream in line 142 may be located above the cold inlet 11 of the fractionation column 140. The kerosene stream taken in the side line 142 may be stripped in a kerosene stripper column 155 to drive off lower boiling materials which are returned back to the fractionation column 140 at a higher elevation in an overhead kerosene line 156. A stripped bottoms kerosene stream is produced in a bottoms kerosene line 157, from which a boil up stream in line 158 is reboiled and fed back to the kerosene stripper column 155 and a jet fuel product stream is taken in line 159. The jet fuel product stream in line 159 meets jet fuel specifications per ASTM D7566 and may be a synthetic paraffinic kerosene (SPK) fuel stream taken from a bottom of the kerosene stripper column 155. The jet fuel product stream in line 159 may be cooled and transported to the jet fuel pool. A bottom stream comprising unconverted oil (UCO) may be taken from a bottom line 144 of the fractionation column 140.

The present process of fractionating the heated liquid flash cold hydroprocessing stream in line 138 and the liquid flash hot hydroprocessing stream in line 128 in the fractionation column 140 comprises the upper reboiler 160 with stripping vapor such as steam injection to maintain heater outlet temperature below about 380° C. (715° F.) to about 391° C. (735° F.). Conventionally, the fractionation column bottom stream is recirculated to reduce vaporization to below 80%. The present process does not require recirculation of the fractionation column bottom stream to reduce vaporization.

### Example

### Example 1

A first comparative study was performed to compare the process comprising a fractionation column comprising an upper reboiler for heating a reboil stream to a process comprising a fractionation column comprising a heater for heating the feed to the fractionation column. The upper reboiler and the heater for the fractionation column for both processes were operated at high efficiency. The results of the study are provided in Table 1 below:

TABLE 1

| | Fractionation | Fractionation column |
|---|---|---|
| | column with heater | with upper reboiler |
| | for feed | for reboiling stream |
| Product Fractionator heater duty | 91 | 48 |
| (MMBTU/HR) | | |
| Stripping steam consumption (ton/hr) | 10.6 | 5.7 |
| Low pressure steam generation from top | 8.0 | — |
| pump-around (ton/hr) | | |
| Low pressure steam generation from | 4.9 | 5.6 |
| kero product (ton/hr) | | |
| Net low pressure steam (export) (ton/hr) | 2.3 | −0.1 |
| Medium pressure steam generation | 5.6 | — |
| from top pump-around (ton/hr) | | |
| Product fractionator overhead | 96.23 | 70.6 |
| condenser duty (MMBTU/HR) | | |

As evident from the results in Table 1, the fractionation column with the upper reboiler required 47% less heater duty than a typical fractionation column with heater for the feed. Also, the fractionation column with the upper reboiler used much less stripping steam than the typical fractionation column. Further, the fractionation column with the upper reboiler required less condenser duty than the typical fractionation column.

### Example 2

A second comparative study was performed to compare the process comprising a fractionation column comprising an upper reboiler for heating a reboiling stream to a process comprising a fractionation column comprising a heater for heating the feed to the fractionation column. The results of the study are provided in Table 2 below:

TABLE 2

| | Fractionation | Fractionation column |
|---|---|---|
| | column with heater | with upper reboiler |
| | for feed | for reboiling stream |
| Product fractionator heater duty | 33 | 15 |
| (MMBTU/HR) | | |
| Stripping steam consumption (ton/hr) | 3.0 | 1.8 |
| Product fractionator overhead | 42 | 27 |
| condenser duty (MMBTU/HR) | | |

As evident form the results in Table 2, the fractionation column with the upper reboiler required about 43% less heater duty than the typical fractionation column with a feed pre-heater for feed. Again, the fractionation column with the upper reboiler used much less stripping steam than the typical fractionation column. Further, the fractionation column with the upper reboiler required lesser condenser duty than the typical fractionation column.

### SPECIFIC EMBODIMENTS

While the following is described in conjunction with specific embodiments, it will be understood that this description is intended to illustrate and not limit the scope of the preceding description and the appended claims.

A first embodiment of the present disclosure is a process of fractionating a stream, comprising fractionating a reactor effluent stream in a fractionation column; taking a reboiling stream from a reboil outlet in a side of the fractionation column; combining the reboiling stream with a stripping vapor stream to provide a mixed reboiling stream; heating the mixed reboiling stream in a reboiler to vaporize less than 70 vol % of the mixed reboiling stream to produce a reboiled stream; charging the reboiled stream to the fractionation column through a reboiled inlet in a side of the fractionation column; and taking an overhead product stream and a bottom product stream from the fractionation column. An embodiment of the present disclosure is one, any or all of prior embodiments in this paragraph up through the first embodiment in this paragraph, wherein the reboiled stream is at a temperature of less than about 385° C. (725° F.). An embodiment of the present disclosure is one, any or all of prior embodiments in this paragraph up through the first embodiment in this paragraph, wherein the reboiled stream comprises less than 50 vol % vapor. An embodiment of the present disclosure is one, any or all of prior embodiments in this paragraph up through the first embodiment in this paragraph further comprising feeding a bottom stripping vapor stream to the fractionation column near a bottom stage of the fractionation column. An embodiment of the present disclosure is one, any or all of prior embodiments in this paragraph up through the first embodiment in this paragraph, wherein the reboiling stream is taken from the reboiled outlet at a location below the reboiled inlet to the fractionation column. An embodiment of the present disclosure is one, any or all of prior embodiments in this paragraph up through the first embodiment in this paragraph, wherein the reboiling stream is taken from the reboiled outlet at a location at least above a last stage of the fractionation column. An embodiment of the present disclosure is one, any or all of prior embodiments in this paragraph up through the first embodiment in this paragraph, wherein the stripping vapor stream is steam. An embodiment of the present disclosure is one, any or all of prior embodiments in this paragraph up through the first embodiment in this paragraph further comprising separating the reactor effluent stream into a cold separator liquid stream and a hot separator liquid stream; and feeding the cold separator liquid stream to the fractionation column at a cold inlet above a hot inlet at which the hot separator liquid stream is fed to the fractionation column. An embodiment of the present disclosure is one, any or all of prior embodiments in this paragraph up through the first embodiment in this paragraph, wherein the cold inlet is located at least one stage above the hot inlet of the fractionation column. An embodiment of the present disclosure is one, any or all of prior embodiments in this paragraph up through the first embodiment in this paragraph further comprising taking a side product stream from the fractionation column; and stripping the side product stream in a side stripper to produce a stripped side product. An embodiment of the present disclosure is one, any or all of prior embodiments in this paragraph up through the first embodiment in this paragraph, wherein the side product stream is a jet fuel stream. An embodiment of the present disclosure is one, any or all of prior embodiments in this paragraph up through the first embodiment in this paragraph, wherein the reactor effluent stream is a hydroprocessed stream. An embodiment of the present disclosure is one, any or all of prior embodiments in this paragraph up through the first embodiment in this paragraph further comprising stripping a hydrocarbon feed stream to produce a stripped hydrocarbon feed stream; hydroprocessing the stripped hydrocarbon feed stream in the presence of a catalyst to produce the hydroprocessed stream; and fractionating the hydroprocessed stream in the fractionation column. An embodiment of the present disclosure is one, any or all of prior embodiments in this paragraph up through the first embodiment in this paragraph, wherein the reactor effluent stream comprises less than 1 wt % sulfur.

A second embodiment of the present disclosure is a process of fractionating a stream, comprising fractionating a reactor effluent stream in a fractionation column; taking a reboiling stream from a reboil outlet in a side of the fractionation column; combining the reboiling stream with a stripping vapor stream to provide a mixed reboiling stream; heating the mixed reboiling stream in a reboiler to vaporize a predetermined portion of the mixed reboiling stream to produce a reboiled stream having a temperature of less than about 385° C. (725° F.); charging the reboiled stream to the fractionation column through a reboiled inlet in a side of the fractionation column; and taking an overhead product stream and a bottom product stream from the fractionation column. An embodiment of the present disclosure is one, any or all of prior embodiments in this paragraph up through the second embodiment in this paragraph, wherein the predetermined portion ranges from about 30 vol % to about 70 vol % of the mixed reboiling stream. An embodiment of the present disclosure is one, any or all of prior embodiments in this paragraph up through the second embodiment in this paragraph further comprising feeding a bottom stripping vapor stream to the fractionation column near a bottom stage of the fractionation column. An embodiment of the present disclosure is one, any or all of prior embodiments in this paragraph up through the second embodiment in this paragraph further comprising separating the reactor effluent stream into a cold separator liquid stream and a hot separator liquid stream; and feeding the cold separator liquid stream to the fractionation column at a cold inlet above a hot inlet at which the hot separator liquid stream is fed to the fractionation column. An embodiment of the present disclosure is one, any or all of prior embodiments in this paragraph up through the second embodiment in this paragraph further comprising stripping a hydrocarbon feed stream to produce a stripped hydrocarbon feed stream; hydroprocessing the stripped hydrocarbon feed stream in the presence of a catalyst to produce a hydroprocessed stream; and fractionating the hydroprocessed stream in the fractionation column.

A third embodiment of the present disclosure is a process of fractionating a stream, comprising fractionating a first liquid stream and a second liquid stream in a fractionation column; taking a reboiling stream from a reboil outlet in a side of the fractionation column; combining the reboiling stream with a stripping vapor stream to provide a mixed reboiling stream; heating the mixed reboiling stream in a reboiler to vaporize less than 70 vol % of the mixed reboiling stream to produce a reboiled stream; charging the reboiled stream to the fractionation column through a reboiled inlet in a side of the fractionation column; and taking an overhead product stream and a bottom product stream from the fractionation column.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process of fractionating a stream, comprising:
fractionating a reactor effluent stream in a fractionation column;
taking a reboiling stream from a reboil outlet in a side of the fractionation column;
combining said reboiling stream with a stripping vapor stream to provide a mixed reboiling stream;
heating said mixed reboiling stream in a reboiler to vaporize less than 70 vol % of said mixed reboiling stream to produce a reboiled stream;
charging said reboiled stream to the fractionation column through a reboiled inlet in a side of the fractionation column; and
taking an overhead product stream and a bottom product stream from the fractionation column.

2. The process of claim 1, wherein said reboiled stream is at a temperature of less than about 385° C.

3. The process of claim 1, wherein said reboiled stream comprises less than 50 vol % vapor.

4. The process of claim 1 further comprising feeding a bottom stripping vapor stream to the fractionation column near a bottom stage of the fractionation column.

5. The process of claim 1, wherein said reboiling stream is taken from said reboiled outlet at a location below said reboiled inlet to the fractionation column.

6. The process of claim 1, wherein said reboiling stream is taken from said reboiled outlet at a location at least above a last stage of the fractionation column.

7. The process of claim 1, wherein said stripping vapor stream is steam.

8. The process of claim 1 further comprising:
separating said reactor effluent stream into a cold separator liquid stream and a hot separator liquid stream; and
feeding said cold separator liquid stream to the fractionation column at a cold inlet above a hot inlet at which said hot separator liquid stream is fed to the fractionation column.

9. The process of claim 8, wherein the cold inlet is located at least one stage above the hot inlet of said fractionation column.

10. The process of claim 9 further comprising:
taking a side product stream from said fractionation column; and
stripping said side product stream in a side stripper to produce a stripped side product.

11. The process of claim 9, wherein said side product stream is a jet fuel stream.

12. The process of claim 1, wherein said reactor effluent stream is a hydroprocessed stream.

13. The process of claim 12 further comprising:
stripping a hydrocarbon feed stream to produce a stripped hydrocarbon feed stream;
hydroprocessing said stripped hydrocarbon feed stream in the presence of a catalyst to produce said hydroprocessed stream; and
fractionating said hydroprocessed stream in the fractionation column.

14. The process of claim 1, wherein said reactor effluent stream comprises less than 1 wt % sulfur.

15. A process of fractionating a stream, comprising:
fractionating a reactor effluent stream in a fractionation column;
taking a reboiling stream from a reboil outlet in a side of the fractionation column;
combining said reboiling stream with a stripping vapor stream to provide a mixed reboiling stream;
heating said mixed reboiling stream in a reboiler to vaporize a predetermined portion of said mixed reboiling stream to produce a reboiled stream having a temperature of less than about 380° C. (715° F.) to about 391° C. (735° F.);
charging said reboiled stream to the fractionation column through a reboiled inlet in a side of the fractionation column; and
taking an overhead product stream and a bottom product stream from the fractionation column.

16. The process of claim 15, wherein the predetermined portion ranges from about 30 vol % to about 70 vol % of said mixed reboiling stream.

17. The process of claim 15 further comprising feeding a bottom stripping vapor stream to the fractionation column near a bottom stage of the fractionation column.

18. The process of claim 15 further comprising:
separating said reactor effluent stream into a cold separator liquid stream and a hot separator liquid stream; and
feeding said cold separator liquid stream to the fractionation column at a cold inlet above a hot inlet at which said hot separator liquid stream is fed to the fractionation column.

19. The process of claim 15 further comprising:
stripping a hydrocarbon feed stream to produce a stripped hydrocarbon feed stream;
hydroprocessing said stripped hydrocarbon feed stream in the presence of a catalyst to produce a hydroprocessed stream; and
fractionating said hydroprocessed stream in the fractionation column.

20. A process of fractionating a stream, comprising:
fractionating a first liquid stream and a second liquid stream in a fractionation column;
taking a reboiling stream from a reboil outlet in a side of the fractionation column;
combining said reboiling stream with a stripping vapor stream to provide a mixed reboiling stream;
heating said mixed reboiling stream in a reboiler to vaporize less than 70 vol % of said mixed reboiling stream to produce a reboiled stream;
charging said reboiled stream to the fractionation column through a reboiled inlet in a side of the fractionation column; and
taking an overhead product stream and a bottom product stream from the fractionation column.
